(19) United States
(12) Patent Application Publication
(10) Pub. No.: US 2010/0049694 A1
(43) Pub. Date: Feb. 25, 2010

(54) METHOD AND SYSTEM FOR EXTENDING A RELATIONAL SCHEMA

(75) Inventor: Tad A. Deffler, Boonton, NJ (US)

Correspondence Address: BAKER BOTTS L.L.P., 2001 ROSS AVENUE, SUITE 600, DALLAS, TX, 75201-2980, US

(73) Assignee: CA, Inc., Islandia, NY (US)

(21) Appl. No.: 12/477,512

(22) Filed: Jun. 3, 2009

Related U.S. Application Data
(60) Provisional application No. 61/090,430, filed on Aug. 20, 2008.

(51) Int. Cl. G06F 17/30; G06F 7/00

(52) U.S. Cl. 707/2; 707/100; 707/101; 707/E17.045; 707/3; 707/E17.014

(57) ABSTRACT

According to one embodiment, a method of accessing data stored in a data store by using a query is provided and includes receiving a first query in a standardized-language at an relational database interface, the first query identifying a first data type. A provider registry is consulted to identify a first provider associated with the first data type. A request specification is transmitted from the relational database interface to the first provider associated with the first data type. Non-relational data of the first data type is received at the relational database interface. The non-relational data is of the first data type received from the first provider in response to the request specification. The non-relational data is converted to relational data at the relational database interface, and the relational data is returned. The relational database interface does not include code relating to how the non-relational data of the first data type is stored by the first provider, how the non-relational data of the first data type is to be retrieved by the first provider, and how the non-relational data is to be manipulated for format conversion.

### RELATED APPLICATION

This patent application claims priority from Patent Application Ser. No. 61/090,430, filed Aug. 20, 2008, METHOD AND SYSTEM FOR EXTENDING A RELATIONAL SCHEMA.

### TECHNICAL FIELD OF THE INVENTION

This invention relates generally to database management systems and more particularly to a method and system for extending a relational schema at runtime.

### BACKGROUND OF THE INVENTION

Open DataBase Connectivity (ODBC) is one example of an Application Programming Interface (API) that provides a common interface for accessing various structure query language (SQL) based database management systems. Using an ODBC or other relational interface, a user may create reports relating to the data managed by the database management systems. One major disadvantage of the conventional ODBC interfaces, however, is that the reporting parameters that are available are based upon the specific object meta data of the product when created. As other areas with in the database management system become subject to reporting, the data associated with these areas may not be represented by the object metadata. Additionally, the format of the data associated with these additional areas may be of a different format from the data that the interface is configured to expose. As such, the code and data that defines the ODBC schema must be modified to convert the new data to the format used by the interface. This process must be performed manually each time another type of data is brought into the system before the existence of the new tables and/or columns can be exposed. Such modifications to the code vastly increases code complexity and stability.

### SUMMARY OF THE INVENTION

According to one embodiment, a method of accessing data stored in a data store by using a query is provided and includes receiving a first query in a standardized-language at an relational database interface, the first query identifying a first data type. A provider registry is consulted to identify a first provider associated with the first data type. A request specification is transmitted from the relational database interface to the first provider associated with the first data type. Non-relational data of the first data type is received at the relational database interface. The non-relational data is of the first data type received from the first provider in response to the request specification. The non-relational data is converted to relational data at the relational database interface, and the relational data is returned. The relational database interface does not include code relating to how the non-relational data of the first data type is stored by the first provider, how the non-relational data of the first data type is to be retrieved by the first provider, and how the non-relational data is to be manipulated for format conversion.

Some embodiments of the invention provide numerous technical advantages. Some embodiments may benefit from some, none, or all of these advantages. For example, one advantage may be that a relational database interface such as an ODBC interface not use a centralized set of system tables. Instead, the schema is dynamically built. Schema names are used as identifiers for schema providers rather than users who build the tables.

Still another advantage may be that additional types of data may be automatically discovered and exposed. Rather than increasing the complexity of existing modules of code that have already been stabilized and tested, additional modules may be added for exposing the new types of data. Accordingly the code for the interface driver, itself, remains stable and does not require modification for each new reportable feature. For example, in a particular embodiment, users may write “Plug Ins” that extend the capabilities of the product. The Plug Ins are created by a third party and bound into the application. Since the interface driver has no knowledge of the implementation of provider, third-party plug-ins can implement the interface and be subject to reporting without the need for developers of the driver interface to be involved.

Still another advantage may be that providers of data register at runtime. The providers can be exposed dynamically as the providers become active. For example, providers can be exposed if an application activates an optional component.

Other technical advantages may be readily ascertainable by one of skill in the art.

### BRIEF DESCRIPTION OF THE FIGURES

For a more complete understanding of the invention, and for further features and advantages, reference is now made to the following description, taken in conjunction with the accompanying drawings, in which:

FIG. 1 is a schematic diagram illustrating a relational database driver interfaced between a report generator and a hierarchical data store, according to an embodiment of the present invention;

FIG. 2 is a schematic illustrating an exemplary hierarchical data store and that of an equivalent relational database, according to an embodiment of the present invention;

FIG. 3 is a graph illustrating some queries performed on exemplary system tables, according to an embodiment of the present invention;

FIG. 4 is a schematic diagram illustrating an example provider registry, according to an embodiment of the present invention;

FIG. 5 is a schematic diagram illustrating a system including a Plug in API, according to an embodiment of the present invention; and

FIGS. 6A and 6B provide a high-level illustration of the differences realized in a system that shifts the performance of data definition and retrieval to a data provider.

### DETAILED DESCRIPTION OF THE INVENTION

Embodiments of the invention and its advantages are best understood by referring to the drawings, like numerals being used for like and corresponding parts of the various drawings.

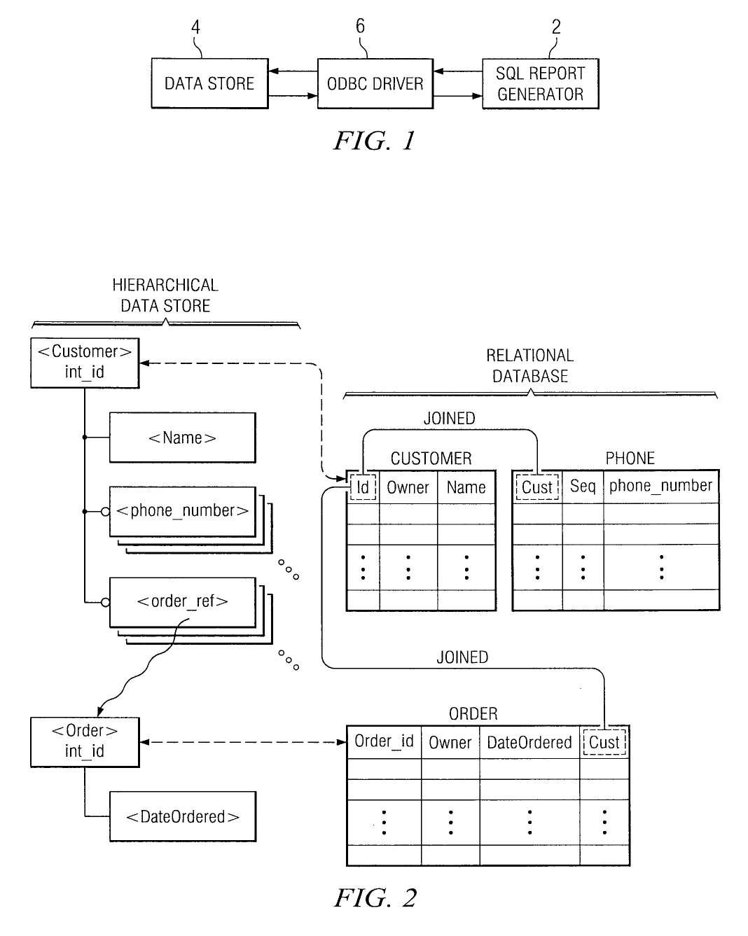

FIG. 1 is a block diagram showing a relational database driver 6 interfaced between a report generator 2 and a data store 4. In a particular embodiment, the interface driver 6 may comprise a ODBC driver. Although a conventional ODBC driver is designed to access relational databases using standard SQL language queries, the interface driver 6 of the present invention allows queries written in a standardized-language such as SQL to be used against a standard object/property model of information such as data store 4 that may or may not include relational data. Thus, where the data is not stored in a relational form, interface driver 6 is responsible for the conversion of the data to a relational form. Additionally and as will be described in more detail below, relational database driver 6 defines an interface for a new component that is capable of providing data and the metadata (schema) that describes the data.

A data store is represented as a graph of objects and properties. Objects may be owned by and conceptually aggregated into other objects. Objects may hold references to other objects via reference properties. Properties are owned by and aggregated into objects. FIG. 2 includes a representation of such an exemplary hierarchical data store and that of an equivalent relational database. However, a hierarchical data store is just one example of a data store that may be accessed by interface driver 6. Data store 4 may include any suitable data store of any suitable format. The format of such data may be unknown to interface driver 6, in particular embodiments.

The exemplary hierarchical data store in FIG. 2 is a model of customers and their order information. The data store includes an object or a group of objects called “Customer” each having a unique internal identification number, “int_id”. The “Customer” object has three properties: one scalar property and two vector properties. The one scalar property is of type “Name” which can hold only one value by definition. The first vector property is of type “Phone_number” which may hold many values by definition. The second vector property is of type “Order ref” which may also hold many values. Each value of “Order ref” is a pointer which references another object called “Order”. The “Order” object has a property of type “DateOrdered” which stores the date of a particular order that has been placed.

As stated above, a relational database interface is responsible for the conversion of the data to a relational form as necessary for interface driver 6. A relational data store equivalent to the exemplary hierarchical data store described above is represented in relational form on the right side of FIG. 2. Specifically, the hierarchical data store can be represented as three separate relational tables. For example, while a “Customer” table has two columns named “Id” and “Name” in FIG. 2, an “Order” table has three columns named “Order_id”, “DateOrdered” and “Cust”, and a “Phone” table has three columns named “Cust”, “Seq” and “Phone_number”. The three tables are linked to each other through “Id” of Customer, “Cust” of Phone and “Cust” of Order which have identical values.

Conventional relational database interfaces such as an ODBC interface expose data during the creation of reports. For example, an ODBC interface may expose only “Modeling Data,” in particular embodiments. However, as the data store matures, it may be desirable to expose other types of data via the same interface for the creation of reports. For example, it may be desirable for the ODBC interface to expose “Action Log Data,” in particular embodiments. Where the Action Log Data is stored in a format completely different from that used for Modeling Data, however, the procedures for converting Action Log Data stored in hierarchical data store 4 to a relational format are somewhat different from the procedures for converting Modeling Data to a relational format.

Although the code that is used to convert the Modeling Data from a hierarchical or other format to a relational format could be modified to handle the conversion of both Modeling Data and Action Log Data, this conversion of the underlying code must be performed each time a new type of data is desired to be exposed. Accordingly, the code must be modified every time another type of data is brought into the system. This is undesirable since it vastly increases code complexity and code stability.

Accordingly, in particular embodiments, it is desirable to expose additional types of data through the addition of a new module instead of increasing the complexity of existing modules that have already been stabilized and tested. Applications exposing their data via the relational database interface allows users to write “Plug Ins” that extend their data. Interface driver 6 is then able to expose and report on that data. A common example of a Plug In includes the components that can be added into an Internet browser to expand its capabilities, such as the Shockwave Flash Player or the Google Toolbar. These are sometimes referred to as “Add Ons” or “Add Ins”.

In the ODBC context, for example, a Plug In may store data of their own of which the ODBC implementation is unaware. Nevertheless, it may be desirable for the ODBC to expose this data for reporting purposes. However, since third-party authors of the Plug In may not have access to underlying source code, the source code cannot be recompiled to enable the modules converting the data to relational form to also handle the data of the Plug In as well. It is desirable then to allow additional types of data to be exposed not only by the addition of a new module without changes to existing modules but also such that the Plug In modules may be added at runtime instead of compile time. The solution employed herein is a runtime delegation of ODBC access to a module based upon schema designation.

### Schemas

When a user executes a command, a database system must be able to uniquely identify the table that is the subject of the command. For example, upon receiving “SELECT*FROM MYTABLE”, the system must be able to identify which table in the database is named MYTABLE. Early implementations of databases solved the problem simply by requiring all names to be unique. Current implementations add the concept of a “schema” to identify a table.

A schema (sometimes called an “owner”) is a specification of which user created the table. Therefore, User1 could create a table called MYTABLE and so could User2. When User 1 executed “SELECT*FROM MYTABLE” the database would recognize that it was User1 logged in and present the data from the table he created. If User2 was logged in, he would receive data from the table he created due to the implicit assumption of ownership.

If User1 actually wanted data from the User2 table, he would have to qualify his query with an explicit instruction to not make the assumption of ownership: “SELECT*FROM User2.MYTABLE”. Most major database vendors support this level of qualification. Given this common approach, schema qualification is a part of the standard defining the SQL for ODBC. A new approach to schema is used herein that equates schema with the module in the program exposing the tables rather than equating schema with the user who created the tables.

### System Tables

Databases systems generally employ a mechanism called System Tables to hold the definition of tables that a user creates in the database. For example, if a user creates a table MYTABLE, then records will be written into some tables maintained solely by the database system that hold that definition. When the database system receives “SELECT ID FROM MYTABLE”, it goes to those system tables and retrieves the definition of MYTABLE in order to understand what is meant. For example, it validates that MYTABLE actually exists; it validates that there is a column called ID in that table; it determines the data type of the ID column; etc.

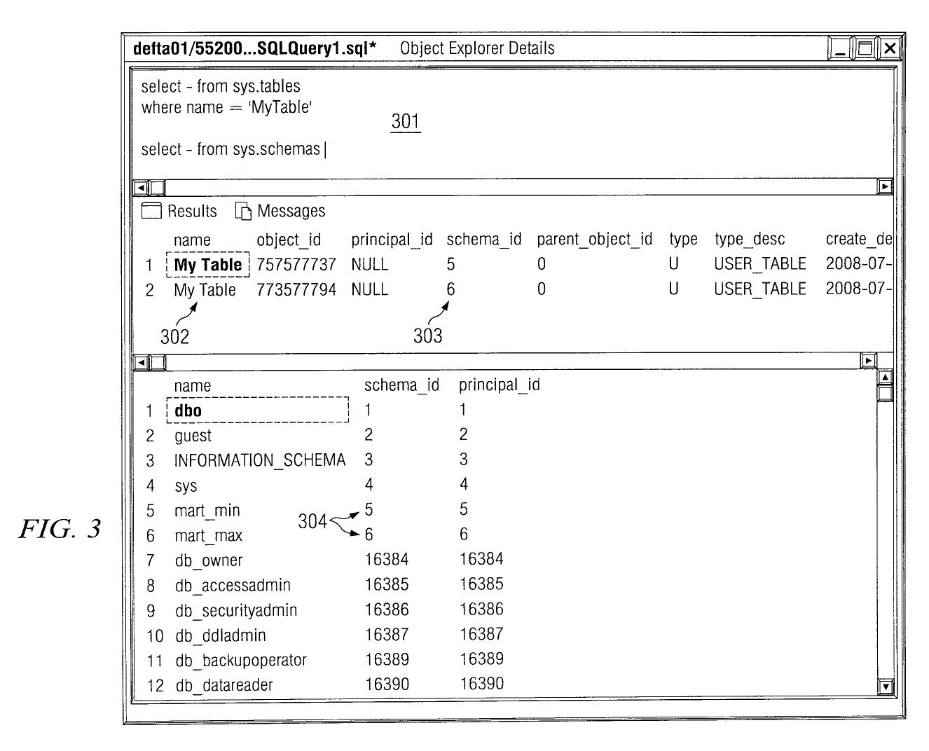

By way of illustration, FIG. 3 shows some queries against exemplary system tables of a SQL Server 2005 database.
Screen portion 301 illustrates that a couple of queries have been executed against the exemplary system tables for the database.
The first query requested all tables named MYTABLE defined in the database.

As can be seen in screen portion 302, the exemplary system tables include two tables named “MYTABLE.” Schema Identifiers 303 indicate that one instance of a MYTABLE is owned by schema 5 and one instance is owned by schema 6.
At screen portion 304, the results of the second query are depicted.

Specifically, screen portion 304 illustrates that schema 5 is called ‘mart_min’ and schema 6 is called ‘mart_max’.

From this information, it can be gleaned that the mart_max user could retrieve his own data by executing “SELECT*FROM MYTABLE” and he could retrieve mart_min's data by executing “SELECT*FROM mart_min.MYTABLE”.

In a relational database system, the database system is responsible for storing the actual contents of a table. Accordingly, centralized system tables are possible. The database system decides how to physically store the data the user defines and, therefore, knows how to retrieve it based upon the descriptions it holds in its system tables. Where the database system is a data store rather than a relational data store, however, this is not the case. A centralized ODBC engine does not know how a Plug In is storing data, how to retrieve it, or how to manipulate it to be in the proper format for the user.

### Solution

According to particular embodiments, the current approach dispenses with system tables. The description and retrieval of data is removed from the relational database interface implementation. Instead, in a particular embodiment, the schema specification is used as a key to locate a new component, which can be added to the application at runtime. The new component knows how to describe and retrieve the data into a common format which the relational database interface implementation can then format into the relational format needed.

First, interface driver 6 defines an interface for a new component called a Provider. An interface is a common programming construct where one piece of code makes a specification of how another piece of code will behave without specifying how it will accomplish that behavior. The second piece of code implements the interface defined by the first piece of code. For example, an interface specification might say: “Implementers will have a method called GetName that retrieves the name of the implementor and returns it as a string to the caller.” Once this is done, any code that understands the interface can retrieve a name from any implementation of the interface by calling GetName without having any further knowledge of the implementation.

A Provider interface specification details that a Provider will be able to:
Provide a unique name for itself.
Describe all data it manages in a specified format.
Given a request for data in the specified format, retrieve that data and provide it to the relational database interface in a return format of our specification.
   Accordingly, driver 6 defines the interface for the new component; however, it is the new component that provides the data and the metadata (schema) that describes the data.

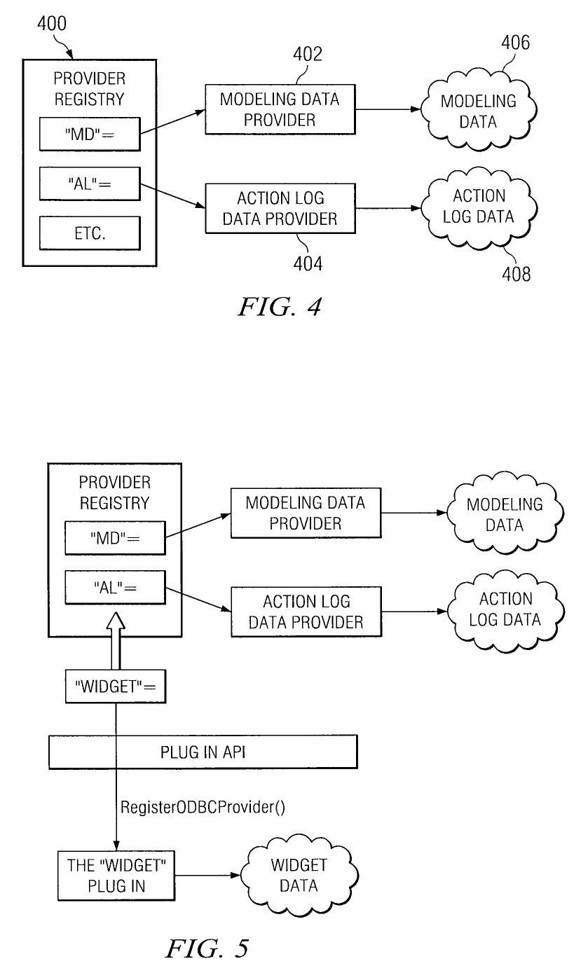

Second, a registry of Providers is included to identify each Provider by a unique name. An example provider registry 400 is illustrated in FIG. 4. The registry maps a name to the provider having that name. For example, as shown in FIG. 4, “MD” of the provider registry uniquely identifies Modeling Data Provider 402. Modeling Data Provider 402 is responsible for retrieving data from Modeling Data 404 and providing it to the relational database interface for reporting purposes. By contrast, “AL” of the provider registry uniquely identifies Action Log Data Provider 406, which is responsible for retrieving data from Action Log Data 408 and providing it to the relational database interface for reporting purposes.

Third, a Plug In API is extended such that a Provider is able to gain access to the registry for registration purposes. FIG. 5 illustrates a system including a Plug in API. Through the Plug in interface, interface driver 6 defines a protocol by which a provider can register itself with the interface driver 6 at runtime. The unused table owner identifier portion of a table designation in a SELECT statement is employed. When registering, the provider is responsible for selecting a unique name to identify itself. This name is treated as the table owner identifier.

Fourth, the structure of the relational database interface is changed such that the relational database interface no longer actually deals with the definition or retrieval of data. For example, the ODBC implementation remains responsible for managing connections from reporting tools, parsing the SQL, etc., but the description of what data was available (the table definitions) and the retrieval of that data are now delegated to the Provider. Accordingly, when a request is received by interface driver 6 for a description of the schema, the response is no longer contained in the code and data of the interface driver 6. Rather, the code and data is produced by aggregating the schema descriptions of each Provider registered with the provider registry 400.

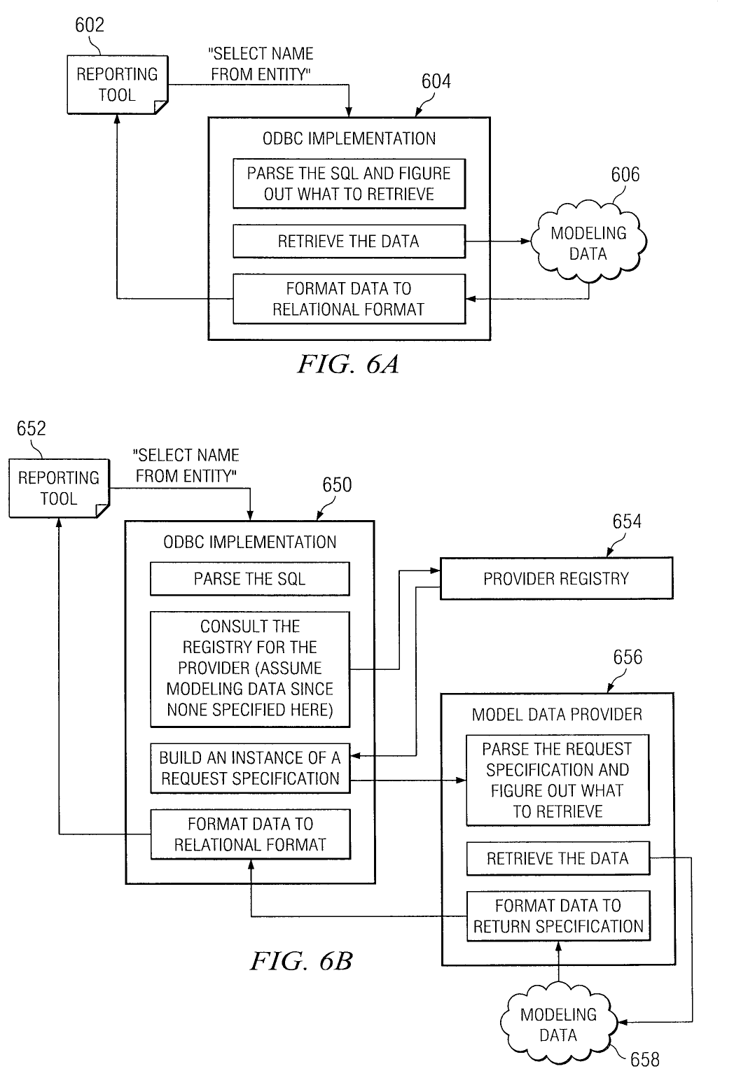

FIGS. 6A and 6B provide a high-level illustration of the difference between the old and new approaches. Specifically, FIG. 6A illustrates an ODBC implementation wherein the ODBC is responsible for the description and retrieval of data. In the example implementation, a user of the ODBC interface uses a reporting tool 602 to issue a “SELECT NAME FROM ENTITY” command. In response to the command, the ODBC implementation 604 parses the SQL command and identifies what data is to be retrieved. ODBC implementation 604 retrieves the data from Modeling Data data store 606 and then converts the data from an unknown format to a relational format.

In contrast, in the ODBC implementation 650 of FIG. 6B, the Provider is responsible for describing the data available and retrieving data in response to a reporting command. In the example implementation, a user of the ODBC interface again uses a reporting tool 652 to issue a “SELECT NAME FROM ENTITY” command. In response to the command, the ODBC implementation 650 parses the SQL command to identify the table owner identifier. When a request for data is received by ODBC driver 650, ODBC driver 650 consults provider registry 654 to identify the Provider associated with the table owner identifier. ODBC implementation 650 then builds an instance of a request specification, which is transmitted to the Model Data Provider 656. Model Data Provider 656 parses the request specification and figures out what data to retrieve from Modeling Data store 658. Provider 656 retrieves the data and then formats the data as required in the return specification. The modeling data is transmitted from Model Data Provider 656 to ODBC implementation 650. ODBC implementation 650 then converts the data from a hierarchical format to a relational format.

Although the present invention has been described in detail, it should be understood that the various changes, substitutions, and alterations could be made hereto without departing from the spirit and scope of the invention as defined by the appended claim. Additionally, systems and methods incorporating some or a combination of the above-described techniques may benefit from some, none, or all of the following advantages.

What is claimed is:

1. A method of accessing data stored in a data store by using a query, comprising the steps of:
receiving a first query in a standardized-language at an relational database interface, the first query identifying a first data type;
consulting a provider registry to identify a first provider associated with the first data type;
transmitting a request specification from the relational database interface to the first provider associated with the first data type;
receiving non-relational data of the first data type at the relational database interface, the non-relational data of the first data type received from the first provider in response to the request specification;
converting the non-relational data to relational data at the relational database interface;
return the relational data, and
wherein the relational database interface does not include code relating to how the non-relational data of the first data type is stored by the first provider, how the non-relational data of the first data type is to be retrieved by the first provider, and how the non-relational data is to be manipulated for format conversion.

2. The method of claim 1, further comprising:
receiving a registration request from the first provider, the registration request received prior to the receipt of the first query, the registration request identifying a set of data types provided by the first provider;
storing the first data type in the provider registry prior to the receipt of the first query; and
associating the first data type with the first provider in the provider registry prior to the receipt of the first query.

3. The method of claim 2, wherein associating the first data type with the first provider comprises maintaining a schema specification comprising a description of the non-relational data of the first data type maintained by the first provider.

4. The method of claim 3, wherein associating the first data type with the first provider comprises associating non-relational data of the first data type with a plurality of providers and wherein the non-relational data maintained by each of the plurality of providers is distinguished by the schema specification.

5. The method of claim 2, wherein the first data type is associated with only the first provider such that the first data type is associated with exactly one provider.

6. The method of claim 2, wherein a first provider is registered at run-time without recompiling the underlying source code used by the relational database interface to perform the conversion of the non-relational data to relational data.

7. The method of claim 1, wherein the data store comprises a hierarchical data store.

8. The method of claim 1, further comprising creating a report to expose the at least one relational database table that is created from the non-relational data, and wherein the at least one relational database table comprises a plurality of data types of a plurality of data formats, the report exposing the plurality of data types of the plurality of data formats.

9. The method of claim 1, further comprising:
receiving a registration request from a second provider, the registration request identifying a second data type;
storing in the second data type in the provider registry;
associating the second data type with the second provider in the provider registry.

10. The method of claim 9, wherein the first data type and the second data type are of differing formats.

11. A system of accessing data stored in a hierarchical data store by using an query, comprising:
a data store comprising a memory storing a provider registry;
a processor in communication with the data store, the processor comprising a report generator; and
a relational database driver interfaced between the report generator and the data store, the driver operable to:
receive a first query in a standardized-language at a relational database interface, the first query identifying a first data type;
consult a provider registry to identify a first provider associated with the first data type;
transmit a request specification to the first provider associated with the first data type;
receive non-relational data of the first data type from the first provider in response to the request specification;
convert the non-relational data to relational data;
return the relational data, and
wherein the relational database driver does not include code relating to how the non-relational data of the first data type is stored by the first provider, how the non-relational data of the first data type is to be retrieved by the first provider, and how the non-relational data is to be manipulated for format conversion.

12. The system of claim 11, wherein the driver is further operable to:
receive a registration request from the first provider, the registration request received prior to the receipt of the first query, the registration request identifying a set of data types provided by the first provider;
store the first data type in the provider registry prior to the receipt of the first query; and
associate the first data type with the first provider in the provider registry prior to the receipt of the first query.

13. The system of claim 12, wherein when associating the first data type with the first provider the driver is operable to maintain a schema specification comprising a description of the non-relational data of the first data type maintained by the first provider.

14. The system of claim 13, wherein when associating the first data type with the first provider the driver is operable to associate non-relational data of the first data type with a plurality of providers, and wherein the non-relational data maintained by each of the plurality of providers is distinguished by the schema specification.

15. The system of claim 12, wherein the first data type is associated with only the first provider such that the first data type associated with exactly one provider.

16. The system of claim 12, wherein the first provider is registered at run-time without recompiling the underlying source code used by the relational database interface to perform the conversion of the non-relational data to relational data.

17. A program storage device readable by at least one processor, tangibly embodying a program of instructions executable by the at least one processor to:
receiving a first query in a standardized-language at an relational database interface, the first query identifying a first data type;
consulting a provider registry to identify a first provider associated with the first data type;
transmitting a request specification from the relational database interface to the first provider associated with the first data type;
receiving non-relational data of the first data type at the relational database interface, the non-relational data of the first data type received from the first provider in response to the request specification;
converting the non-relational data to relational data at the relational database interface;
return the relational data, and
wherein the relational database interface does not include code relating to how the non-relational data of the first data type is stored by the first provider, how the non-relational data of the first data type is to be retrieved by the first provider, and how the non-relational data is to be manipulated for format conversion.

18. The program storage device of claim 17, further executable by the at least one processor to:
receive a registration request from the first provider, the registration request received prior to the receipt of the first query, the registration request identifying a set of data types provided by the first provider;
store the first data type in the provider registry prior to the receipt of the first query; and
associate the first data type with the first provider in the provider registry prior to the receipt of the first query.

19. The program storage device of claim 18, further executable by the at least one processor to:
associate the first data type with the first provider by maintaining a schema specification comprising a description of the non-relational data of the first data type maintained by the first provider.

20. The program storage device of claim 18, further executable by the at least one processor to:
associate the first data type with the first provider by associating non-relational data of the first data type with a plurality of providers, and
wherein the non-relational data maintained by each of the plurality of providers is distinguished by the schema specification.

21. The program storage device of claim 18, wherein the first data type is associated with only the first provider such that the first data type is associated with exactly one provider.

22. The program storage device of claim 18, wherein the first provider is registered at run-time without recompiling the underlying source code used by the relational database interface to perform the conversion of the non-relational data to relational data.

23. The program storage device of claim 17, wherein the data store comprises a hierarchical data store.

24. The program storage device of claim 17, further executable by the at least one processor to:
create a report to expose the at least one relational database table that is created from the non-relational data, and
wherein the at least one relational database table comprises a plurality of data types of a plurality of data formats, the report exposing the plurality of data types of the plurality of data formats.

25. The program storage device of claim 17, further executable by the at least one processor to:
receive a registration request from a second provider, the registration request identifying a second data type;
store in the second data type in the provider registry;
associate the second data type with the second provider in the provider registry.

26. The program storage device of claim 25, wherein the first data type and the second data type are of differing formats.
